(19) United States
(12) Patent Application Publication
(10) Pub. No.: US 2025/0076071 A1
(43) Pub. Date: Mar. 6, 2025

(54) INFORMATION PROVIDING METHOD AND INFORMATION PROVIDING SERVER

(71) Applicant: TOYOTA JIDOSHA KABUSHIKI KAISHA, Toyota-shi (JP)

(72) Inventor: Junpei OKAMOTO, Sayama-shi (JP)

(73) Assignee: TOYOTA JIDOSHA KABUSHIKI KAISHA, Toyota-shi (JP)

(21) Appl. No.: 18/815,176

(22) Filed: Aug. 26, 2024

(30) Foreign Application Priority Data
Aug. 28, 2023 (JP) 2023-138180

(51) Int. Cl. G01C 21/36; G01C 21/00

(52) U.S. Cl. CPC G01C 21/3673; G01C 21/3807

(57) ABSTRACT

An information providing method provides information indicative of a distribution of addresses of individuals, and includes: prestoring, as a database for a plurality of individuals, information from which an address can be at least partially identified and a predetermined attribute in association with each other (step S112); extracting, from the database, individuals having the predetermined attribute that satisfies a predetermined condition (step S122); creating information indicative of a distribution of addresses of the extracted individuals (step S123 and step S124); and providing the created information indicative of the distribution to a user (step S125). In the creating the information indicative of the distribution, the information indicative of the distribution for each cluster of addresses is created in a manner that prevents identification of the addresses of the individuals. Accordingly, identification of the addresses of the individuals can be prevented.

### CROSS REFERENCE TO RELATED APPLICATIONS

This nonprovisional application is based on Japanese Patent Application No. 2023-138180 filed on Aug. 28, 2023 with the Japan Patent Office, the entire contents of which are hereby incorporated by reference.

### BACKGROUND

### Field

The present disclosure relates to an information providing method and an information providing server, and particularly to an information providing method and an information providing server that provide information indicative of a distribution of addresses of individuals.

### Description of the Background Art

Conventionally, on a map displayed on a screen, a symbol image may be displayed at a location of a facility such as a store, and a symbol image indicative of collective display may be displayed at a place where there is a high concentration of facilities (see Japanese Patent Laying-Open No. 2012-173154, for example).

### SUMMARY

A method of displaying information on a map, such as the one described in Japanese Patent Laying-Open No. 2012-173154, could be applied to display of addresses of individuals. When a single symbol image is displayed at a location where there is a high concentration of individuals of interest, the address of each of the concentrated individuals is not easily identified. When a single symbol image is displayed at a location where there is not a high concentration of individuals of interest (e.g., at a location where one person or one family resides), on the other hand, the addresses of these individuals may be known to others who see this screen. Thus, when information related to addresses of individuals is displayed on a map, there is a risk that the addresses of the individuals may be identified.

The present disclosure provides an information providing method and an information providing server that can prevent identification of an address of an individual.

An information providing method according to the present disclosure provides information indicative of a distribution of addresses of individuals, and includes: prestoring, as a database for a plurality of individuals, information from which an address can be at least partially identified and a predetermined attribute in association with each other; extracting, from the database, individuals having the predetermined attribute that satisfies a predetermined condition; creating information indicative of a distribution of addresses of the extracted individuals; and providing the created information indicative of the distribution to a user. In the creating the information indicative of the distribution, the information indicative of the distribution for each cluster of addresses is created in a manner that prevents identification of the addresses of the individuals.

According to such a configuration, individuals having the predetermined attribute that satisfies a predetermined condition are extracted from the database that prestores, for a plurality of individuals, information from which an address can be at least partially identified and a predetermined attribute in association with each other; information indicative of a distribution for each cluster of addresses is created in a manner that prevents identification of the addresses of the extracted individuals; and the created information indicative of the distribution is provided to a user. As a result, an information providing method that can prevent identification of an address of an individual can be provided.

In the creating the information indicative of the distribution, the information indicative of the distribution may be created by excluding a cluster including a predetermined number or less of individuals among clusters of addresses.

According to such a configuration, even when a cluster of addresses includes the predetermined number or less of individuals, identification of the addresses of the individuals can be prevented.

The information indicative of the distribution may be an image, and in the creating the information indicative of the distribution, the information indicative of the distribution may be created such that a position of an image indicative of collective information for each cluster of addresses does not overlap a position of an address of an individual included in this cluster.

According to such a configuration, identification of the address of the individual by the position of the image indicative of collective information for each cluster of addresses can be prevented.

In the creating the information indicative of the distribution, the information indicative of the distribution may be created by regarding, when a plurality of individuals have a same address and a house of this address is a single-family dwelling, these individuals as one person, while regarding, when a plurality of individuals have a same address and a house of this address is multiple-family dwellings, these individuals as a number of individuals having the same address.

According to such a configuration, when a plurality of individuals have the same address and a house of this address is a single-family dwelling, the individuals are likely to belong to the same family, and therefore, the individuals are regarded as one family (one person) instead of a plurality of different people, which can allow for creation of the information indicative of the distribution in a manner that prevents identification of the address of the family. Additionally, when a plurality of individuals have the same address and a house of this address is multiple-family dwellings, the number of individuals can be accurately counted.

The information indicative of the distribution may be an image indicative of the distribution. The information indicative of the distribution may be a list indicative of the distribution.

According to another aspect of the present disclosure, an information providing server provides information indicative of a distribution of addresses of individuals. The information providing server includes: a storage unit that prestores, as a database for a plurality of individuals, information from which an address can be at least partially identified and a predetermined attribute in association with each other; and a processor. The processor extracts, from the database, individuals having the predetermined attribute that satisfies a predetermined condition; creates information indicative of a distribution for each cluster of addresses of the extracted individuals in a manner that prevents identification of addresses of the individuals; and provides the created information indicative of the distribution to a user.

According to such a configuration, an information providing server that can prevent identification of an address of an individual can be provided.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing an overview of a configuration of an information providing system according to the present embodiment.

FIG. 2 is a flowchart showing an individual distribution presentation process performed by a server of the information providing system in the present embodiment.

FIG. 3 is a diagram showing an exemplary database of individual information in the present embodiment.

FIG. 4 is a first diagram showing an exemplary transition of an image presented on a display of an output unit of a terminal device in the present embodiment.

FIG. 5 is a second diagram showing an exemplary transition of an image presented on the display of the output unit of the terminal device in the present embodiment.

### DESCRIPTION OF THE PREFERRED EMBODIMENTS

Embodiments of the present disclosure will be hereinafter described in detail with reference to the drawings, in which the same or corresponding portions are denoted by the same reference characters and description thereof will not be repeated.

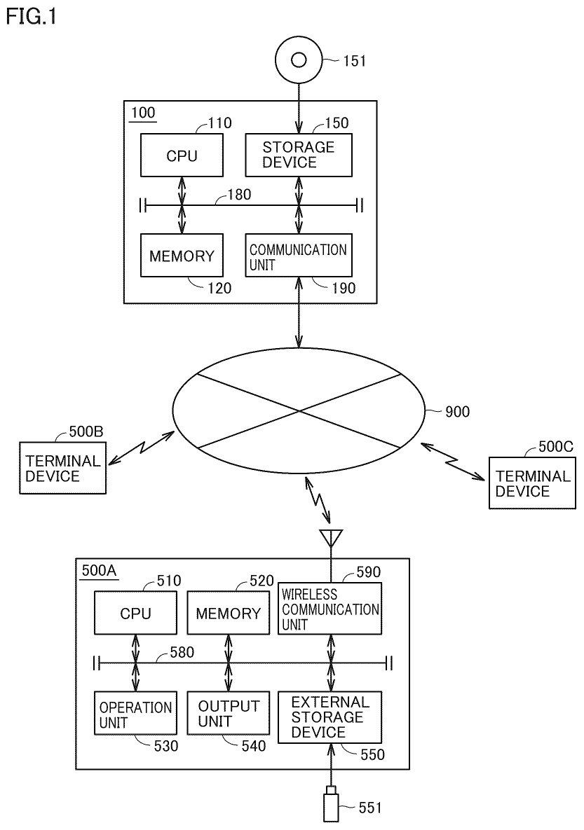

FIG. 1 is a diagram showing an overview of a configuration of an information providing system 1 according to the present embodiment. Referring to FIG. 1, information providing system 1 includes a server 100 and terminal devices 500A to 500C (hereinafter representatively referred to as a “terminal device 500”) of a plurality of users. Server 100 and terminal device 500 can communicate with each other via a communication network 900. Communication network 900 includes a private network such as a LAN (Local Area Network) or a VPN (Virtual Private Network), and a public network such as the Internet, a public circuit or a public wireless LAN.

Server 100 includes a CPU (Central Processing Unit) 110, a memory 120, a storage device 150, and a communication unit 190. CPU 110, memory 120, storage device 150, and communication unit 190 are connected to one another via a bus 180.

Memory 120 includes a RAM (Random Access Memory) used as a work area required for CPU 110 to execute a program, and a ROM (Read Only Memory) for storing a program to be executed by CPU 110. In addition, a program and data for performing predetermined processing are read from the ROM or the like and stored in the RAM.

Storage device 150 is implemented by a hard disk drive, a DVD (Digital Versatile Disk) drive, a memory card reader/writer, or the like. Storage device 150 magnetically, optically, or electrically records predetermined data or program received from CPU 110 on a recording medium 151, and reads the data or program from recording medium 151 and provides it to CPU 110. Examples of recording medium 151 include a magnetic disk such as a hard disk, an optical disk such as a DVD-ROM (Digital Versatile Disk Read Only Memory), a memory card, and a USB (Universal Serial Bus) memory.

Communication unit 190 transmits and receives data to and from an external device (e.g., terminal device 500) via communication network 900. Communication unit 190 transmits data received from a device connected to bus 180 such as CPU 110 to the outside, and provides data received from the outside to a device connected to bus 180 such as CPU 110.

CPU 110 controls memory 120, communication unit 190 and storage device 150, performs predetermined processing in accordance with a program and data stored in memory 120, processes data received from communication unit 190 and storage device 150, and causes the processed data to be stored in memory 120, to be output from communication unit 190 to another device, and to be stored in recording medium 151 of storage device 150.

While server 100 does not include an operation unit and a display unit in the present embodiment, server 100 is not limited as such and may be configured to include an operation unit and a display unit. The operation unit may include a keyboard and a mouse, and an operation signal indicative of operation content that is input to server 100 by operation of the keyboard and the mouse of the operation unit may be provided to CPU 110. The display unit may include an LCD (Liquid Crystal Display), for example, and the LCD may display an image corresponding to image data received from CPU 110.

Terminal device 500 includes a CPU 510, a memory 520, an operation unit 530, an output unit 540, an external storage device 550, and a wireless communication unit 590. CPU 510, memory 520, operation unit 530, output unit 540, external storage device 550, and wireless communication unit 590 are connected to one another via a bus 580. As CPU 510 and memory 520 are the same as CPU 110 and memory 120 of server 100, the same description will not be repeated.

External storage device 550 is implemented by a memory card reader/writer.

External storage device 550 electrically records predetermined data or program received from CPU 510 on a recording medium 551 such as a memory card or a USB (Universal Serial Bus) memory, and reads the data or program from recording medium 551 and provides it to CPU 510. External storage device 550 may be implemented by a storage device such as a hard disk drive, a flexible disk drive, an MO (Magneto-Optical disk) drive, a CD (Compact Disc) drive, or a DVD (Digital Versatile Disk) drive.

Operation unit 530 includes a touch panel and operation buttons for entering numbers, alphabets and other characters, such as a telephone number and various data. Operation unit 530 may include portions for other operations. Operation of operation unit 530 by a user causes an operation signal corresponding to the operation to be transmitted from operation unit 530 to CPU 510. CPU 510 controls each unit of terminal device 500 in response to the operation signal from operation unit 530.

Wireless communication unit 590 is controlled by CPU 510 to receive, via a public circuit and an antenna, a wireless signal from another terminal device 500 or a landline telephone to which a call is being placed, convert the received wireless signal into an audio signal and transmit the converted audio signal to an audio input/output unit, and convert the audio signal from the audio input/output unit into a wireless signal and transmit, via an antenna and a communications facility of a telecommunications carrier, the wireless signal to another terminal device 500 or the landline telephone to which the call is being placed.

Wireless communication unit 590 is also controlled by CPU 510 to receive, via a public circuit and an antenna, a wireless signal from a device capable of data communication, for example, server 100 or another terminal device 500, convert the received wireless signal into data and store the converted data in memory 520 or transmit the converted data to output unit 540 in order to display the data, and convert data to be transmitted into a wireless signal and transmit, via an antenna and a communications facility of a telecommunications carrier, the wireless signal to server 100 or another terminal device 500 to which the data is to be communicated.

Wireless communication unit 590 is also controlled by CPU 510 to exchange, via a public wireless LAN or a private network wireless LAN, data with other devices capable of network communication, for example, server 100 and another terminal device 500.

Output unit 540 includes a display and a speaker. Output unit 540 is controlled by CPU 510 to display an image signal on the display as an image and output an audio signal from the speaker as sound. The image signal and the audio signal are obtained by converting, by CPU 510, information received by wireless communication unit 590, information stored in memory 520, or information read from recording medium 551 in external storage device 550.

While terminal device 500 has been described as a mobile terminal such as a smartphone, terminal device 500 is not limited as such and may be another information processing device such as a PC (Personal Computer) or a tablet.

Conventionally, on a map presented on the display of output unit 540 of terminal device 500, a symbol image may be displayed at a location of a facility such as a store, and a symbol image indicative of collective display may be displayed at a place where there is a high concentration of facilities.

Such a method of displaying information on a map could be applied to display of addresses of individuals. When a single symbol image is displayed at a location where there is a high concentration of individuals of interest, the address of each of the concentrated individuals is not easily identified. When a single symbol image is displayed at a location where there is not a high concentration of individuals of interest (e.g., at a location where one person or one family resides), on the other hand, the addresses of these individuals may be known to others who see this screen. Thus, when information related to addresses of individuals is displayed on a map, there is a risk that the addresses of the individuals may be identified.

Therefore, an information providing method may include: prestoring, as a database for a plurality of individuals, information from which an address can be at least partially identified and a predetermined attribute in association with each other; extracting, from the database, individuals having the predetermined attribute that satisfies a predetermined condition; creating information indicative of a distribution of addresses of the extracted individuals; and providing the created information indicative of the distribution to a user. In the creating the information indicative of the distribution, the information indicative of the distribution for each cluster of addresses may be created in a manner that prevents identification of the addresses of the individuals.

Accordingly, individuals having the predetermined attribute that satisfies a predetermined condition are extracted from the database that prestores, for a plurality of individuals, information from which an address can be at least partially identified and a predetermined attribute in association with each other; information indicative of a distribution for each cluster of addresses is created in a manner that prevents identification of the addresses of the extracted individuals; and the created information indicative of the distribution is provided to a user. As a result, identification of the addresses of the individuals can be prevented.

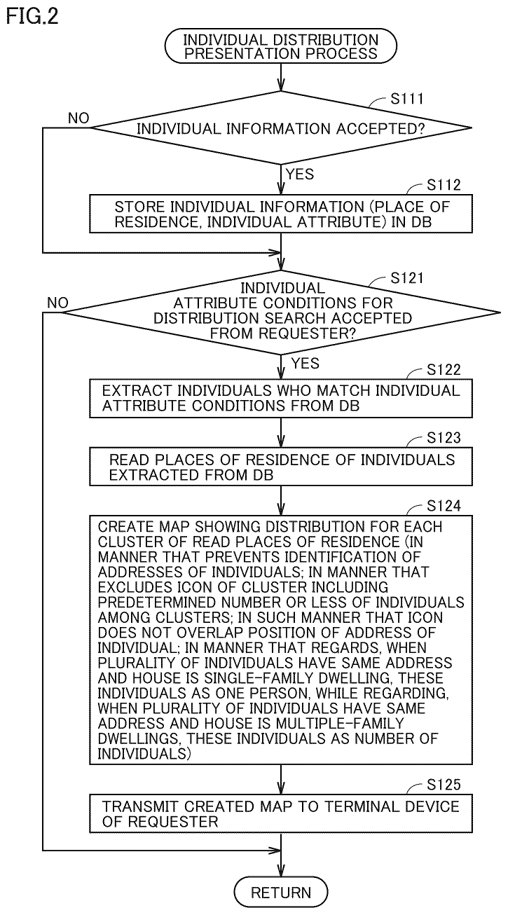

FIG. 2 is a flowchart showing an individual distribution presentation process performed by server 100 of information providing system 1 in the present embodiment. Referring to FIG. 2, this individual distribution presentation process is called from a higher level process and performed by CPU 110 of server 100.

CPU 110 determines whether or not individual information has been accepted from an employee or an individual of an operator, which is a legal entity that operates information providing system 1, via communication unit 190 (step S111). The individual information includes a place of residence of this individual and an attribute of this individual. When it is determined that individual information has been accepted (YES in step S111), the accepted individual information is added to and stored in a database that is stored in storage device 150 of server 100.

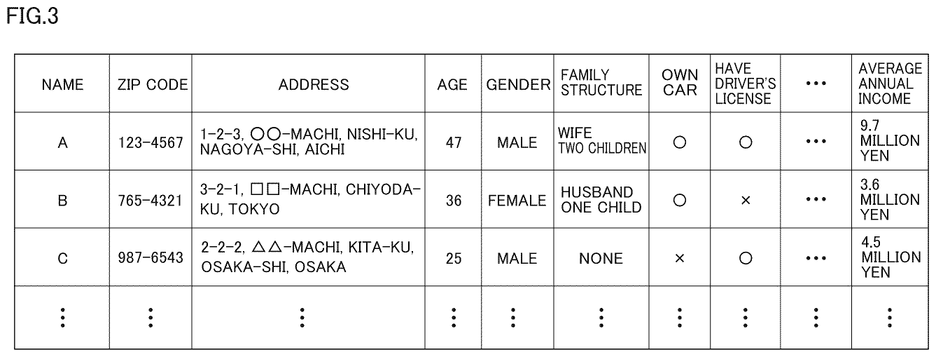

FIG. 3 is a diagram showing an exemplary database of individual information in the present embodiment. Referring to FIG. 3, the database stored in storage device 150 of server 100 stores information related to a place of residence of an individual and information related to an attribute of an individual in association with each other. While the information related to a place of residence of an individual as used herein includes a zip code and address, other information related to a place of residence of an individual may additionally or alternatively be included. While the information related to an attribute of an individual includes a name, age, gender, family structure, information indicative of whether or not the individual owns a car, information indicative of whether or not the individual has a driver's license, and average annual income, other information related to an attribute of an individual may additionally or alternatively be included.

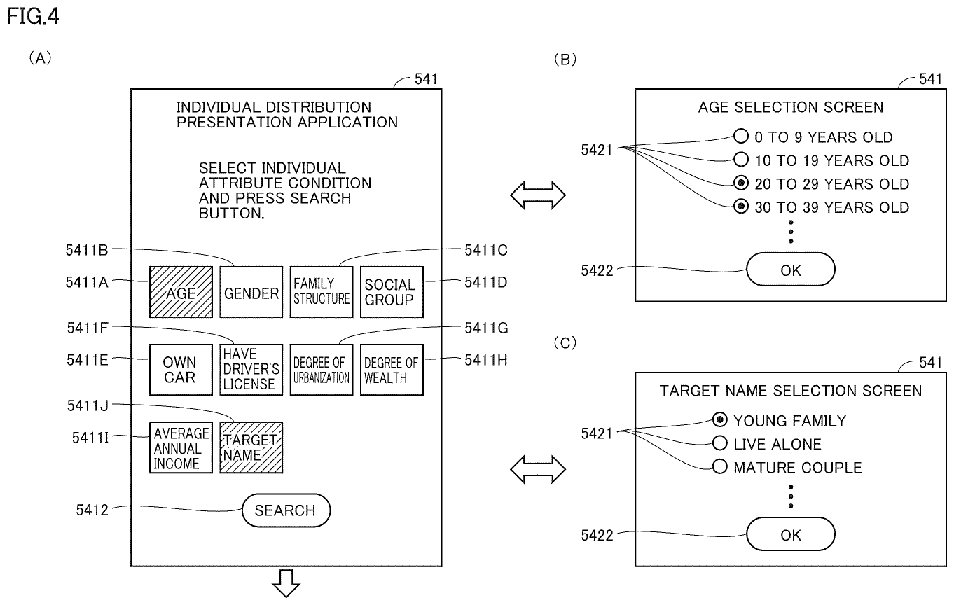

FIG. 4 is a first diagram showing an exemplary transition of an image presented on a display 541 of output unit 540 of terminal device 500 in the present embodiment. Referring to FIG. 4, an individual distribution presentation application is an application program provided by the operator of information providing system 1, and is installed and used in terminal device 500 of a requester in order to provide, from the operator of information providing system 1 to the requester, a distribution of places of residence of individuals who satisfy conditions for predetermined individual attributes.

When the individual distribution presentation application is launched in terminal device 500 to perform an operation for starting a distribution search, a screen shown in FIG. 4 (A) is presented on display 541 of output unit 540 of terminal device 500. The screen shown in FIG. 4 (A) includes: characters “INDIVIDUAL DISTRIBUTION PRESENTATION APPLICATION” which is the name of this application; text that prompts selection of a condition for an individual attribute and pressing of a search button; select buttons 5411A to 5411J for selecting individual attributes; and a search button 5412. Other information may additionally or alternatively be included in the screen shown in FIG. 4 (A).

When “AGE” select button 5411A is pressed, for example, on the screen shown in FIG. 4 (A), a screen shown in FIG. 4 (B) is presented on display 541 of output unit 540 of terminal device 500. The screen shown in FIG. 4 (B) includes: characters “AGE SELECTION SCREEN” which is the name of this screen; a plurality of radio buttons 5421 for selecting a desired option from options of conditions for the age of individuals for which a distribution is desired to be searched; and an OK button 5422 for confirming the selection. For example, as shown in FIG. 4 (B), a “20 to 29 years old” option and a “30 to 39 years old” option are changed from a non-selected state (a state of a white circle in the figure) to a selected state (a state of a black circle in the white circle in the figure) by pressing of radio buttons 5421 corresponding to these options. Pressing of OK button 5422 in this state confirms the selection of the conditions of the “20 to 29 years old” option and the “30 to 39 years old” option.

When “TARGET NAME” select button 5411J is pressed, for example, on the screen shown in FIG. 4 (A), a screen shown in FIG. 4 (C) is presented on display 541 of output unit 540 of terminal device 500. The target name is a name indicative of a target that includes a combination of multiple types of individual attributes. For example, a “YOUNG FAMILY” is the name of a target that is a younger generation (e.g., 20 to 29 years old) and that has family members such as a spouse and children. A “MATURE COUPLE” is a name indicative of a target that is an older generation (e.g., 60 years or older) and that consists of only spouses.

The screen shown in FIG. 4 (C) includes: characters “TARGET NAME SELECTION SCREEN” which is the name of this screen; a plurality of radio buttons 5421 for selecting a desired option from options of conditions for the target name of individuals for which a distribution is desired to be searched; and an OK button 5422 for confirming the selection. For example, as shown in FIG. 4 (C), a “YOUNG FAMILY” option is changed from a non-selected state (a state of a white circle in the figure) to a selected state (a state of a black circle in the white circle in the figure) by pressing of radio button 5421 corresponding to this option. Pressing of OK button 5422 in this state confirms the selection of the condition of the “YOUNG FAMILY” option.

After the selections of the conditions for the individual attributes have been confirmed on the screens shown in FIG. 4 (B) and FIG. 4 (C), the screen is returned to the one shown in FIG. 4 (A). On the screen of FIG. 4 (A), after the conditions for any of the individual information have been confirmed, the select buttons (select buttons 5411A and 5411J in this case) corresponding to the individual attributes for which the conditions have been confirmed are displayed in a different manner (in a hatched manner in this case) from the select buttons of the other individual attributes for which the conditions have not been confirmed.

On the screen shown in FIG. 4 (A), a “SOCIAL GROUP” of select button 5411D refers to a social group to which an individual belongs. The social group includes, as options for conditions, groups in which regularity and persistence are observed in interaction and interrelationship in humans, for example, a company employee (a group whose occupation is an employee of a company), and an farmer (a group whose occupation is farming). A “DEGREE OF URBANIZATION” of select button 5411G refers to the degree to which the area of a place of residence is urbanized, which is indicated, for example, by a level of population density. A “DEGREE OF WEALTH” refers to the degree of wealth of a household, which is indicated, for example, by a level of household income.

When the conditions for the individual attributes for which a search is desired to be performed are confirmed on the screen of FIG. 4 (A), search button 5412 is pressed by the requester. When search button 5412 is pressed in terminal device 500, CPU 510 executing the individual distribution presentation application controls wireless communication unit 590 to transmit the confirmed conditions for the individual attributes for a distribution search to server 100 via communication network 900.

Returning to FIG. 2, when it is determined that individual information has not been accepted in server 100 (NO in step S111), and after step S112, CPU 110 determines whether or not individual attribute conditions for a distribution search have been accepted at communication unit 190 from terminal device 500 of the requester via communication network 900 (step S121).

When it is determined that individual attribute conditions have been accepted (YES in step S121), CPU 110 extracts, from the database shown in FIG. 3, individuals who match the accepted individual attribute conditions (step S122). When the accepted individual attribute conditions include a condition that the age is 40 to 49 years old and a condition that the individual owns a car, for example, an individual with a name A who matches these individual attribute conditions is extracted.

CPU 110 then reads places of residence of the extracted individuals (step S123). For example, a zip code and address of the individual with name A are read.

CPU 110 creates a map showing a distribution for each cluster of the read places of residence in a manner that prevents identification of the addresses of the individuals (step S124). CPU 110 controls communication unit 190 to transmit the created map to terminal device 500 of the requester via communication network 900 (step S125). When it is determined that individual attribute conditions have not been accepted (NO in step S121), and after step S125, CPU 110 returns the process to be performed to the higher level process from which this individual distribution presentation process was called.

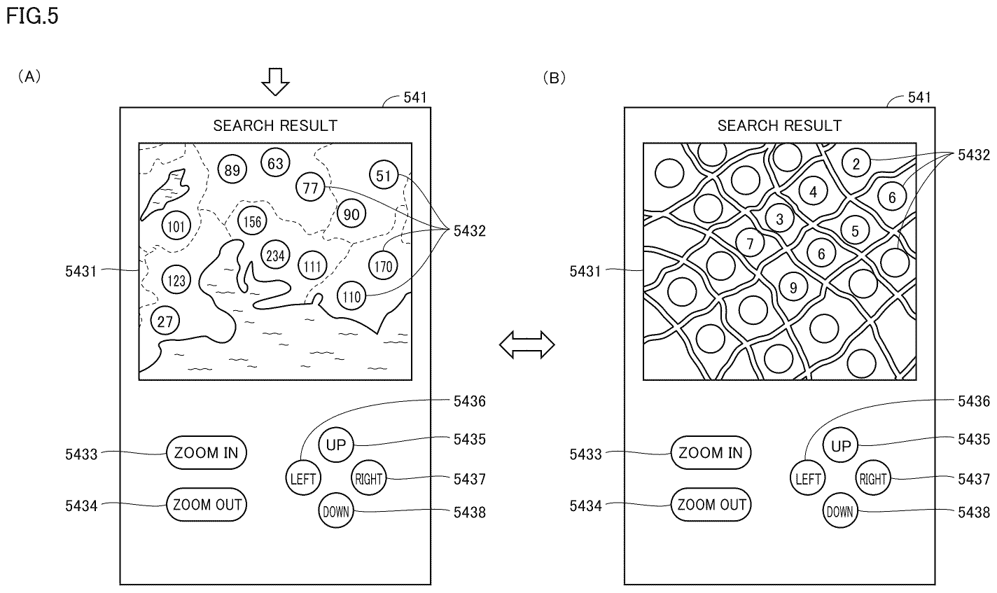

FIG. 5 is a second diagram showing an exemplary transition of an image presented on display 541 of output unit 540 of terminal device 500 in the present embodiment. Referring to FIG. 5, in terminal device 500, when the created map is received by wireless communication unit 590 from server 100 via communication network 900, CPU 510 controls display 541 of output unit 540 to display the received map on a screen shown in FIG. 5 (A).

The screen shown in FIG. 5 (A) includes: characters “SEARCH RESULT” which is the name of the screen; an image 5431 showing the received map; a zoom in button 5433 for zooming in on the map; a zoom out button 5434 for zooming out of the map; and move buttons 5435 to 5438 for moving the map up, left, right and down, respectively.

Image 5431 in FIG. 5 (A) shows a distribution of individuals for each cluster of places of residence matching the individual attribute conditions selected by the requester, in a region centered in Aichi Prefecture. In image 5431 of FIG. 5 (A), the range of the cluster is, for example, approximately a range determined by dividing a prefecture into several areas, such as eastern Aichi Prefecture, central Aichi Prefecture, and western Aichi Prefecture. Each icon 5432 of collective information for each cluster is, in this case, an image in which the number of individuals who match the individual attribute conditions and who belong to the cluster is included in a circle. For example, in FIG. 5 (A), icons 5432 of collective information for each cluster indicate that 156 individuals who match the individual attribute conditions selected by the requester reside in eastern Aichi Prefecture, 234 matching individuals reside in central Aichi Prefecture, and 111 matching individuals reside in western Aichi Prefecture.

When zoom in button 5433 is pressed on the screen of FIG. 5 (A), image 5431 is displayed in a zoomed-in mode. When this zoomed-in display is repeated several times, image 5431 is displayed in the most zoomed-in mode, as indicated by a screen shown in FIG. 5 (B). In image 5431 of FIG. 5 (B), the range of the cluster is a section surrounded by roads. For example, in FIG. 5 (B), icons 5432 of collective information for each cluster indicate that 2, 6, 4, 5, 3, 6, 7, and 9 individuals who match the individual attribute conditions selected by the requester reside in the respective clusters.

In image 5431 of FIG. 5 (B), when icon 5432 is displayed in which the number of individuals who match the individual attribute conditions and who belong to this cluster, indicated by the number of icon 5432 of collective information, is equal to or less than a predetermined number, and when the number of these individuals substantially matches the number of dwellings belonging to this cluster, there is a high possibility that the individuals having these individual attribute conditions are identified as residing in these dwellings. In step S124 of FIG. 2, therefore, the map is created such that image 5431 does not include any icon 5432 in which the number of individuals who match the individual attribute conditions and who belong to this cluster, indicated by the number of icon 5432 of collective information, is equal to or less than a predetermined number. This predetermined number may be determined in consideration of population density, building density, or the degree of urbanization.

In image 5431 of FIG. 5 (B), when icon 5432 of collective information overlaps the position of a place of residence of an individual who matches the individual attribute conditions and who belongs to this cluster, there is a high possibility that this individual is identified as residing in the overlapping position. In step S124 of FIG. 2, therefore, the map is created such that icon 5432 of collective information is shifted so as not to overlap the position of a place of residence of an individual who matches the individual attribute conditions and who belongs to this cluster, or such that icon 5432 is displayed at a position where there is no building.

In step S124 of FIG. 2, the map is created by regarding, when a plurality of individuals have the same address and a house of this address is a single-family dwelling, these individuals as one person, while regarding, when a plurality of individuals have the same address and a house of this address is multiple-family dwellings, these individuals as a number of individuals having the same address. Accordingly, when a plurality of individuals have the same address and a house of this address is a single-family dwelling, the individuals are likely to belong to the same family, and therefore, the individuals are regarded as one family (one person) instead of a plurality of different people, which can allow for creation of the map in a manner that prevents identification of the address of the family. Additionally, when a plurality of individuals have the same address and a house of this address is multiple-family dwellings, the number of individuals can be accurately counted.

### [Modifications]

(1) In the embodiment described above, the information indicative of the distribution is image 5431 such as a map, as shown in FIG. 5. However, the information indicative of the distribution is not limited as such and may be a list. This list may include information identifying a cluster and the number of individuals who match individual attribute conditions for each cluster in association with each other.

(2) In the embodiment described above, the range of the cluster is approximately a range determined by dividing a prefecture into several areas, and a section surrounded by roads, as shown in FIG. 5. However, the range of the cluster is not limited as such and may be a range of the same zip code, a range of the same prefecture, a range of the same city, ward, town or village, a range of the same area code of telephone number, or a range predetermined by the operator of information providing system 1.

(3) In the embodiment described above, the map is created in a manner that prevents identification of the addresses of the individuals in step S124, as shown in FIG. 2. The present disclosure is not limited as such, and the application side of terminal device 500 may operate in a manner that prevents identification of the addresses of the individuals. For example, when zooming in on image 5431, CPU 510 may control output unit 540 not to display any icon 5432 of collective information for a cluster in which the number of individuals who match the individual attribute conditions and who belong to the cluster is equal to or less than a predetermined number.

(4) In the embodiment described above, the place of residence of an individual is identified by an address, as shown in FIG. 3. However, the present disclosure is not limited as such, and the place of residence of an individual may be identified by other information, for example, a latitude and a longitude. In this case, the range of the cluster may be determined by a latitude and a longitude.

(5) The foregoing disclosure can be considered as disclosure of information providing system 1, an information providing server such as server 100, or an information processing device such as terminal device 500, as shown in FIG. 1; can be considered as disclosure of an information providing method performed by an information providing server and an information processing device in information providing system 1; can be considered as disclosure of an information providing program executed by an information providing server or an information processing device; and can be considered as disclosure of computer-readable recording media 151 and 551 having an information providing program recorded thereon, as shown in FIG. 2.

### CONCLUSION

(1) As shown in FIGS. 1 to 5, an information providing method provides information indicative of a distribution of addresses of individuals. As shown in FIGS. 2 and 3, the information providing method includes prestoring, as a database for a plurality of individuals, information from which an address can be at least partially identified and a predetermined attribute in association with each other (e.g., step S112 of FIG. 2). As shown in FIGS. 2 and 5, the information providing method includes: extracting, from the database, individuals having the predetermined attribute that satisfies a predetermined condition (e.g., step S122 of FIG. 2); creating information indicative of a distribution of addresses of the extracted individuals (e.g., step S123 and step S124 of FIG. 2); and providing the created information indicative of the distribution to a user (e.g., step S125 of FIG. 2). As shown in step S124 of FIG. 2 and FIG. 5, in the creating the information indicative of the distribution, the information indicative of the distribution for each cluster of addresses is created in a manner that prevents identification of the addresses of the individuals.

Accordingly, individuals having the predetermined attribute that satisfies a predetermined condition are extracted from the database that prestores, for a plurality of individuals, information from which an address can be at least partially identified and a predetermined attribute in association with each other; information indicative of a distribution for each cluster of addresses is created in a manner that prevents identification of the addresses of the extracted individuals; and the created information indicative of the distribution is provided to a user. As a result, identification of the addresses of the individuals can be prevented.

(2) As shown in step S124 of FIG. 2, in the creating the information indicative of the distribution, the information indicative of the distribution may be created by excluding a cluster including a predetermined number or less of individuals among clusters of addresses.

Accordingly, even when a cluster of addresses includes the predetermined number or less of individuals, identification of the addresses of the individuals can be prevented.

(3) As shown in step S124 of FIG. 2, the information indicative of the distribution may be an image, and in the creating the information indicative of the distribution, the information indicative of the distribution may be created such that a position of an image indicative of collective information for each cluster of addresses does not overlap a position of an address of an individual included in this cluster.

Accordingly, identification of the address of the individual by the position of the image indicative of collective information for each cluster of addresses can be prevented.

(4) As shown in step S124 of FIG. 2, in the creating the information indicative of the distribution, the information indicative of the distribution may be created by regarding, when a plurality of individuals have a same address and a house of this address is a single-family dwelling, these individuals as one person, while regarding, when a plurality of individuals have a same address and a house of this address is multiple-family dwellings, these individuals as a number of individuals having the same address.

Accordingly, when a plurality of individuals have the same address and a house of this address is a single-family dwelling, the individuals are likely to belong to the same family, and therefore, the individuals are regarded as one family (one person) instead of a plurality of different people, which can allow for creation of the information indicative of the distribution in a manner that prevents identification of the address of the family. Additionally, when a plurality of individuals have the same address and a house of this address is multiple-family dwellings, the number of individuals can be accurately counted.

(5) As shown in FIG. 5, the information indicative of the distribution may be an image indicative of the distribution.

(6) As described in the modification (1), the information indicative of the distribution may be a list indicative of the distribution.

Although the embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. An information providing method that provides information indicative of a distribution of addresses of individuals, the method comprising:
prestoring, as a database for a plurality of individuals, information from which an address can be at least partially identified and a predetermined attribute in association with each other;
extracting, from the database, individuals having the predetermined attribute that satisfies a predetermined condition;
creating information indicative of a distribution of addresses of the extracted individuals; and
providing the created information indicative of the distribution to a user, wherein
in the creating the information indicative of the distribution, the information indicative of the distribution for each cluster of addresses is created in a manner that prevents identification of the addresses of the individuals.

2. The information providing method according to claim 1, wherein in the creating the information indicative of the distribution, the information indicative of the distribution is created by excluding a cluster including a predetermined number or less of individuals among clusters of addresses.

3. The information providing method according to claim 1, wherein
the information indicative of the distribution is an image, and
in the creating the information indicative of the distribution, the information indicative of the distribution is created such that a position of an image indicative of collective information for each cluster of addresses does not overlap a position of an address of an individual included in this cluster.

4. The information providing method according to claim 1, wherein in the creating the information indicative of the distribution, the information indicative of the distribution is created by regarding, when a plurality of individuals have a same address and a house of this address is a single-family dwelling, these individuals as one person, while regarding, when a plurality of individuals have a same address and a house of this address is multiple-family dwellings, these individuals as a number of individuals having the same address.

5. The information providing method according to claim 1, wherein the information indicative of the distribution is an image indicative of the distribution.

6. The information providing method according to claim 1, wherein the information indicative of the distribution is a list indicative of the distribution.

7. An information providing server that provides information indicative of a distribution of addresses of individuals, the server comprising:
a storage unit that prestores, as a database for a plurality of individuals, information from which an address can be at least partially identified and a predetermined attribute in association with each other; and
a processor, wherein
the processor
extracts, from the database, individuals having the predetermined attribute that satisfies a predetermined condition,
creates information indicative of a distribution for each cluster of addresses of the extracted individuals in a manner that prevents identification of addresses of the individuals, and
provides the created information indicative of the distribution to a user.
